(19) United States
(12) Patent Application Publication
(10) Pub. No.: US 2006/0196008 A1
(43) Pub. Date: Sep. 7, 2006

(54) Door closer

(76) Inventor: Vesa Karkkainen, Joensuu (FI)

Correspondence Address: SMITH-HILL AND BEDELL, P.C., 16100 NW CORNELL ROAD, SUITE 220, BEAVERTON, OR, 97006, US

(21) Appl. No.: 11/345,002

(22) Filed: Jan. 31, 2006

(30) Foreign Application Priority Data
Feb. 2, 2005 (FI) 20050120

(51) Int. Cl. E05F 1/00

(52) U.S. Cl. 16/71

(57) ABSTRACT

A door closer includes a body having an external surface and defining an interior space. The body is formed with a passage extending from the external surface of the door closer body and communicating with the interior space. A valve member is located in the passage between the interior space and the external surface of the door closer body. The valve member has a gasket groove and a gasket is fitted in the gasket groove. The gasket groove is configured to allow the gasket to protrude from the groove and/or break when the pressure in the interior space exceeds the pressure at the external surface by a predetermined amount and thereby allow door closer fluid in the interior space to escape from the door closer.

### CROSS-REFERENCE TO RELATED APPLICATION

This application claims priority under 35 USC 119 of Finnish Patent Application No. 20050120 filed Feb. 2, 2005.

### BACKGROUND OF THE INVENTION

1. Field of Technology

This invention relates to a door closer, particularly to relief valve structures for door closer fluid.

2. Prior Art

A conventional door closer comprises a door closer body defining an interior space that contains a door closer fluid, which is usually oil, and includes a cylindrical chamber. A piston is fitted slidingly in the cylindrical chamber and is urged towards one end of the chamber by a spring. When the door is opening, the door closer piston moves against resistance of the door closer spring and oil flows through a passage from one side of the piston (referred to for convenience as the open side of the piston) to the other side of the piston (referred to as the closed side of the piston). When the force of the spring closes the door, the oil flows back from the closed side of the piston to the open side of the piston through a separate flow passage having its cross-sectional area adjusted appropriately by a valve to make the door close smoothly, not abruptly.

The interior space of the door closer body is the space that contains door closer fluid or may receive the flow of door closer fluid. Thus the interior space includes the volumes on both sides of the door closer piston, as well as the channel or channels between these volumes.

A door closer is usually installed at the top edge of the door, which is the hottest part of the door in case of fire. In the event of a fire, the pressure of the door closer fluid rises due to increased temperature, and in the worst case, the increase in pressure may cause the oil to burst uncontrollably out of the door closer at high pressure and catch fire, which is not desirable and might not be acceptable in fire tests conducted on door closers.

The fire side of the door is not a problem because everything will burn anyway when the temperature reaches approximately 1000° C. On the outside, the non-fire side, the temperature of the door may rise to some 400° C. (Standards specify varying requirements for the temperature of the outside, ranging approximately from 180° to 400° C.) In order to meet fire safety standards, a door closer that is installed on the outside of a door must not aid in spread of the fire from the fire side to the non-fire side. Designing a door closer to meet this requirement is a challenge for door closer manufacturers.

If there is no exit route for over-pressurized oil, the oil will most often emerge from the door closer shaft neck and may be directed upwards or towards the door with high pressure, which may cause the door to catch fire. In the worst case, the door closer body may crack. Therefore an exit route should be provided for over-pressurized oil in a door closer. The structure that provides an exit route for over-pressurized oil is also called a relief valve structure.

Patent Publication GB 2349173 discloses a prior art relief valve structure in which there is a plugged aperture on the top of the door closer body. The plug will melt due to heat, allowing the oil to emerge from the door closer through the aperture. The top of the door closer body is provided with raised edges that cause the emerged oil to remain in a pool on the top surface of the door closer with the intention that it will smoke and evaporate due to the heat. The problem with this solution is that the oil may still catch fire on the top surface of the door closer, particularly at higher temperatures. Furthermore, the point in time when the plug melts, that is, the valve opens, depends strongly on external circumstances (such as the structure of the door and of the wall in which the door is installed).

Another known relief valve structure is a spring valve structure disclosed in Patent Publication GB 2315808. Spring valve structures operate in response to an increase in door closer fluid pressure, which means that their operation is more predictable than that of valve structures that operate directly in response to the increase in temperature. However, spring valve structures are relatively complex and expensive.

### SUMMARY OF THE INVENTION

The objective of the invention is to provide a more advantageous and less complex solution compared to relief valve structures based on an increase in door closer fluid pressure.

A valve according to the invention includes a gasket groove fitted with a gasket, the groove being arranged to allow the door closer fluid to emerge from the door closer so that the gasket groove allows the gasket to protrude from the groove and/or break once the fluid pressure within the door closer reaches a certain level.

### BRIEF DESCRIPTION OF THE DRAWINGS

In the following, the invention is described in more detail by reference to the enclosed drawings, where

FIG. 1 illustrates an example of a relief valve construction according to the invention under normal oil pressure,

FIG. 2 illustrates another example of a relief valve construction according to the invention that also serves as a control valve, under normal oil pressure,

FIG. 3 illustrates the example of FIG. 2 with the oil in the door closer at over-pressure, and

FIG. 4 illustrates schematically a door closer that may be provided with a relief valve structure embodying the invention.

### DETAILED DESCRIPTION

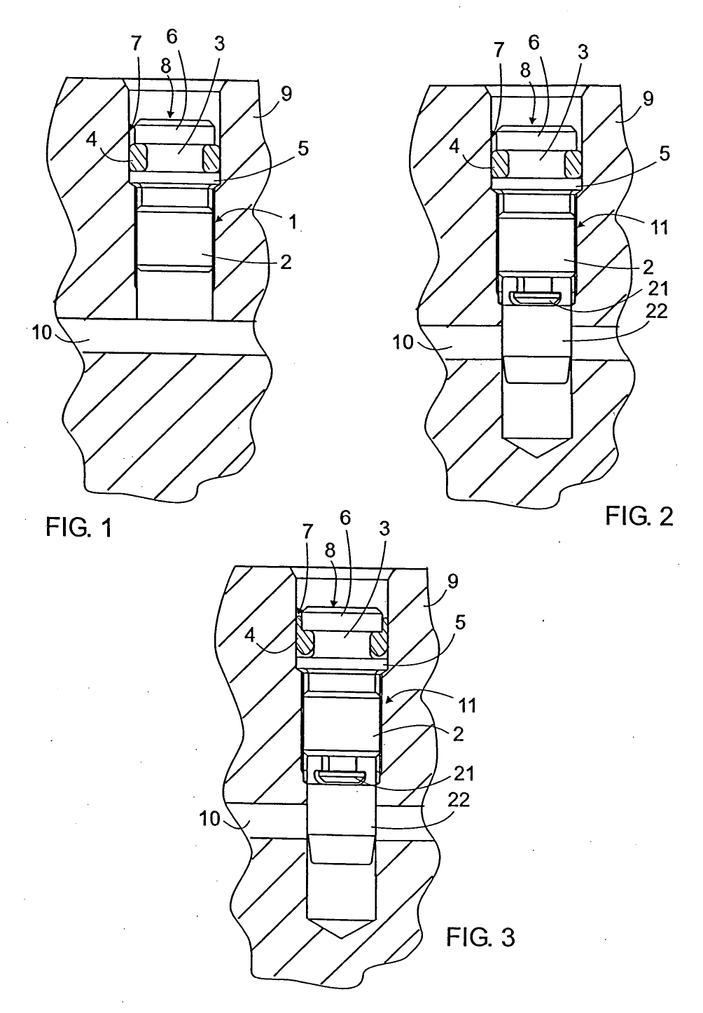

FIG. 1 illustrates an example of a relief valve structure embodying the invention under normal oil pressure. The valve 1 comprises a threaded part 2 for screwing the valve into a bore in the door closer body 9, which is formed with at least one channel 10. The channel 10 is part of the interior space of the door closer body. The surface 8 of the outer end of the valve has a formation or recess (such as a hexagonal socket or a crosshead socket) for an installation tool. The outer end also includes a groove 3 for a gasket 4. The gasket prevents oil from leaking out of the channel 10 in the door closer body under normal operating conditions. The gasket groove 3 is defined between an inner wall or flange 5 and an outer wall or flange 6. The gasket provides a seal between the base of the groove and the interior surface of the segment of the bore that contains the gasket.

Around at least part of its circumference, the outer wall 6 of the gasket groove 3 is formed so that when installed in the door closer, a sufficient gap 7 remains between the outer wall 6 and the door closer body 9 in order for the gasket to protrude as specified. It is preferred that the gap 7 exists around the entire circumference of the outer wall 6 so that it will not contact the door closer body at any location. The inner wall 5 of the groove is preferably a wall that lightly contacts the door closer edge, or the gap between it and the body is very small. It should be noted that in some embodiments, the outer wall 6 may comprise parts similar to the inner wall 5.

FIG. 2 illustrates an example of a relief valve structure 11 embodying the invention that also serves as a control valve. In addition to the parts in FIG. 1, the embodiment of FIG. 2 comprises a control part 22 that is attached to the rest of the valve structure through a fastening projection 21. FIG. 2 also illustrates the door closer at normal pressure. It should be noted that because the valve includes the control part 22, the bore made in the door closer body is deeper than in the embodiment of FIG. 1.

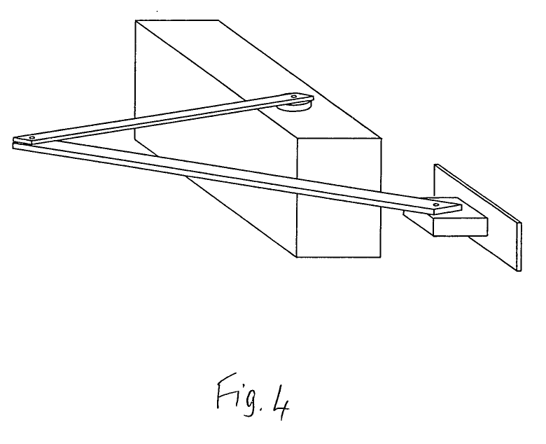

FIG. 3 illustrates a situation in which over-pressurized fluid has started to force the gasket out of the groove. As shown in FIG. 3, the gasket enters the gap 7. The entire gasket may be forced out of the groove 3, through the gap 7, but in other situations part of the gasket may be forced from the groove, into and through the gap, providing a passage through which oil can flow to the exterior of the valve body. The distortion of the gasket due to the pressure of oil may also cause the gasket to break, providing a passage for escape of oil. FIG. 3 illustrates the embodiment of FIG. 2, but naturally, a similar situation may occur in the embodiment of FIG. 1 and in any other potential embodiments of the invention.

It should be noted that the valve structure embodying the invention is intended to be placed between the interior space of the door closer and the outside of the door closer. The valve can be placed in the door closer body so that it is in connection with the desired part of the internal chamber. Instead of being in connection with the internal channel 10 as illustrated in FIGS. 1 to 3, it may be in connection with the volume on the closed side of the piston, for example.

The valve 1, 11 is arranged so that in normal circumstances it prevents the door closer oil from leaking out, but at a sufficient level of over-pressure, for example an oil pressure level of 100 bar, it allows the oil to leak out. It is preferred that the oil escapes gradually, because if it bursts out suddenly (for example due to cracking of the body) or rapidly, it will catch fire more easily. Dimensioning can be used to adjust the tripping pressure to suit different types of door closer bodies or installation locations.

FIG. 4 illustrates a door closer that may be provided with a relief valve structure embodying the present invention. The valve structure is preferably located on the bottom or front side of the door closer body (away from the door itself) to prevent the emerging oil from contacting the door or remaining on top of the door closer. These are the locations where the oil will more easily catch fire. Even if the door closer is covered by a plastic housing, this will not hamper operation. The fact that the door closer is leaking oil at the valve location when the valve opens does not usually cause any problems as the oil comes out gradually.

In a practical implementation of the invention, the segment of the bore that contains the gasket is 8 mm in diameter. The most common implementation of the valve gasket is an O-ring gasket (typically an O-ring having a thickness of 2 mm) and a groove intended for an O-ring, and the radial distance between the base of the groove and the interior surface of the bore is 1.45 mm. Conventionally, if an O-ring is to be installed on a member similar to the threaded member shown in FIG. 1 (for example, as shown in U.S. Pat. No. 5,992,444), by placing the O-ring in a groove between inner and outer walls, the walls of the groove are dimensioned to support the O-ring so that the O-ring remains in the groove regardless of the pressure (within design limits) across the O-ring. For example, in the case of the bore 13 shown in U.S. Pat. No. 5,992,444 being 8 mm in diameter and the O-ring having a thickness of 2 mm, the inner and outer walls of the adjustment member are typically from 7.85 to 7.9 mm, so that the radial clearance between the walls and the interior surface of the bore is from 0.05 to 0.075 mm. And in the event of the radial distance between the base of the groove and the interior surface of the bore being 1.45 mm, the radial height of the outer wall from the base of the groove is about 95% of the radial distance between the base of the groove and the interior surface of the bore. However, in the relief valve structures shown in FIGS. 1-3, the radial height of the inner wall 5 remains about 1.375 to 1.4 mm, as in the conventional adjustment member, but the radial height of the outer wall 6 is smaller, so that when fluid pressure within the door closer reaches a certain level, the outer wall 6 of the gasket groove no longer supports the gasket and allows the gasket 4 to protrude from the groove and/or break. In practice, this may be accomplished by forming the outer wall so that its radial height is from 0.95 to 0.97 mm, so that there is a radial clearance of 0.48 to 0.5 mm between the outer wall 6 and the interior surface of the bore and/or the radial height of the outer wall 6 is approximately ⅔ of the distance between the base of the groove and the interior surface of the bore.

As described, the invention relates to a door closer with a relief valve structure based on the increase of door closer fluid pressure. The relief valve structure is completely different from prior solutions and less complex. Manufacture is also more economical compared to prior art solutions. Because valve operation is based on an increase in fluid pressure, it is very predictable. This means that the same relief valve structure is applicable to many different installations without separate customization. Applicability to different types of door closers is also good, as a valve structure embodying the invention can be placed at the desired position within the desired door closer without any major advance design.

The invention also relates to a door closer in which at least one valve is a combined relief valve and control valve. A combined control valve and relief valve is a very advantageous solution for arranging an exit route for over-pressurized oil, as there is no need to make a separate bore in the door closer, and the same valve serves two different functions.

FIGS. 1 to 3 illustrate certain potential embodiments of the invention but other embodiments are possible as well. For example, the control valve gasket groove can be modified in many ways.

It thus evident that the invention is not limited to the examples mentioned in this text but can be implemented in many other different embodiments within the scope of the inventive idea.

1. A door closer comprising:
a body having an external surface and defining an interior space, the body being formed with a passage extending from the external surface of the door closer body and communicating with the interiol space,
a valve member located in said passage between the interior space and the external surface of the door closer body, the valve member having a gasket groove, and
a gasket fitted in the gasket groove,
wherein the gasket groove is configured to allow the gasket to protrude from the groove and/or break when pressure in the interior space exceeds pressure at the external surface by a predetermined amount and thereby allow door closer fluid in the interior space to escape from the door closer.

2. A door closer according to claim 1, wherein the gasket groove is bounded by an outer wall of the valve member and the outer wall is formed to leave a gap between the outer wall and a bounding surface of the passage for allowing the gasket to protrude from the gasket groove.

3. A door closer according to claim 1, wherein the valve allows gradual escape of door closer fluid from the interior space when the pressure in the interior space exceeds the pressure at the external surface by said predetermined amount.

4. A door closer according to claim 1, wherein the door closer body has a bottom region and a front region, and the passage is provided in the bottom region or front region of the door closer body.

5. A door closer according to claim 1, wherein the gasket is an O-ring and the gasket groove is configured to receive an O-ring.

6. A door closer according to claim 1, wherein the valve includes a control element that cooperates with the valve body to function as a control valve of the door closer.

7. A valve for installation in a door closer that comprises a body having an external surface and defining an interior space, the body being formed with a passage that extends from the external surface of the door closer body and communicates with the interior space and is internally threaded, the valve comprising a member having an externally threaded segment for engaging the internal thread of the passage and also having a gasket groove, and a gasket fitted in the gasket groove, the gasket groove being configured to allow the gasket to protrude from the groove and/or break when pressure in the interior space of the door closer body exceeds pressure at the external surface by a predetermined amount and thereby allow door closer fluid in the interior space to escape from the door closer.
